(19) United States
(12) Patent Application Publication
(10) Pub. No.: US 2025/0334015 A1
(43) Pub. Date: Oct. 30, 2025

(54) Subsea Christmas Tree Comprising a Control and Battery Module and Related Method

(71) Applicant: FMC Kongsberg Subsea AS, Kongsberg (NO)

(72) Inventors: Heyn H Magnus, Kongsberg (NO); Christian Meum, Kongsberg (NO); Vidar Nicolaysen, Kongsberg (NO)

(21) Appl. No.: 18/875,140

(22) PCT Filed: Jun. 20, 2023
(86) PCT No.: PCT/EP2023/066676

§ 371 Date: Dec. 14, 2024

(30) Foreign Application Priority Data
Jun. 20, 2022 (NO) 20220696

(51) Int. Cl. E21B 33/035; E21B 34/04; H01M 50/251

(52) U.S. Cl. CPC E21B 33/0355; E21B 34/04; H01M 50/251; H01M 2220/10

(57) ABSTRACT

A subsea hydrocarbon Christmas tree having a control and battery module (100) for controlling electrically actuated valves (200) is described. The control and battery module comprises a plurality of subsea electronics modules (110A, 110B) configured for receiving electric power provided from a top-side power supply (300) to operate the valves. The control and battery module also comprises a plurality of battery pack modules (120A, 120B, 120C). At least one of the plurality of battery pack modules (120B, 120C) is connectable to the subsea electronics modules to provide supplement electric power to the subsea electronics modules should electric power required for a desired valve operation exceed electric power provided to the subsea electronics modules from the top-side power supply. A related method is also described.

### FIELD OF THE INVENTION

The present invention relates to a subsea hydrocarbon Christmas tree comprising a control and battery module and a related method. In particular, the present invention relates to a Christmas tree comprising a control and battery module for controlling electrically actuated valves, each valve being actuated by an electric motor, and means for reducing top-side energy transfer capacity requirements.

### BACKGROUND

Within the art of subsea hydrocarbon production, it has been suggested to use all-electric systems to operate valves in Christmas trees. Providing reliable power in such systems requires the power distribution infrastructure, e.g. top-side power lines or umbilicals, to be dimensioned for worst case, peak power scenarios. Even if such cases are rare, the power distribution infrastructure must be dimensioned to handle these scenarios. This is a problem since providing for peak power capacity is costly.

GB2364396B discloses an electric actuator system for a subsea environment. The actuator contains at least one electric motor, at least one electrical storage unit (rechargeable battery), and a control unit. The control unit contains switching means for controlling the power to the motor and an intelligent processor which receives signals relating to the state of the electrical storage unit, and of an external power supply, and preferably external information and/or control signals. The controller connects the motor to a selected power source to move the actuator to a desired position according to the received signals. In the event of loss of external power, the controller can allow the actuator to continue to function as long as the storage unit has adequate power, thus preventing unnecessary shutdowns.

GB2476238A discloses an underwater well installation comprises a chemical flow battery. The flow battery may be supplied with operating chemicals via flowlines located in an umbilical cable. The power generated may be supplemental to any electrical power received via a conventional power supply line in an umbilical.

### SUMMARY OF THE INVENTION

With the abovementioned challenge in mind, and according to a first aspect, the present disclosure provides a subsea hydrocarbon Christmas tree comprising a control and battery module for controlling electrically actuated valves, each valve being actuated by an electric motor, the control and battery module comprising:
a plurality of subsea electronics modules configured for receiving electric power provided from a top-side power supply to operate the valves; and
a plurality of battery pack modules.

The plurality of battery pack modules comprises at least one battery pack module which is connectable to the plurality of subsea electronics modules to provide supplement electric power to the plurality of subsea electronics modules should electric power required for a desired valve operation exceed electric power provided to the plurality of subsea electronics modules from the top-side power supply.

In other words, when the electric power required for a desired valve operation exceeds the electric power provided by the top-side power supply (the “top-side electric power”), the supplement electric power provided by the at least one battery pack module (the “supplement electric power”) will supplement the top-side electric power such that the top-side electric power and the supplement electric power jointly power the valves.

The at least one battery pack module may typically be configured to be activated to provide supplementary power in power peak situations, thus allowing the top-side power distribution infrastructure to be dimensioned for a power rating which is less than the maximum power that may, in some rare situations, be required to operate the valves. This will reduce cost associated with top-side power lines or umbilicals.

The plurality of battery pack modules may comprise two or more battery pack modules which are connectable to the plurality of subsea electronics modules to provide said supplement electric power to the plurality of subsea electronics modules.

Each of the battery pack modules may be connectable to each of the plurality of subsea electronics modules to provide said supplement electric power to each of the plurality of subsea electronics modules.

The at least one battery pack module which is connectable to the plurality of subsea electronics modules to provide said supplement electric power may be arranged to provide supplement electric power to a plurality of subsea electronics modules in parallel.

On/off switches may be arranged between the battery pack module(s) providing supplement electric power and the subsea electronics modules to realise such a coupling scheme. In particular, if there is a plurality of battery pack modules providing supplement electric power, an on/off switch may preferably be arranged between each of battery pack modules and each of the subsea electronics modules.

The plurality of battery pack modules may be made in accordance with IEC 61508.

In addition to providing supplement power for the operation of the valves, the plurality of battery pack modules may advantageously be configured to form part of a power redundancy system of the control and battery module.

Consequently, said plurality of battery pack modules may advantageously be configured to provide not only supplement electric power to the control and battery module, i.e. power supplementing uninterrupted top-side electric power, but also back-up electric power, i.e. power substituting interrupted top-side electric power, thus allowing, for example, the control and battery module to effectuate a redundantly powered shut-down or closing of the Christmas tree should power from the top-side power supply be interrupted.

For example, the plurality of battery pack modules may comprise a first sub-set of battery pack modules comprising at least one battery pack module configured for providing back-up electric power, i.e. electric power configured to be provided from the battery pack module(s) to the subsea electronics modules to substitute top-side electric power should the top-side electric power be interrupted, and a second sub-set comprising at least one battery pack module configured for providing supplement electric power, i.e. electric power configured to be provided from the battery pack module(s) to the subsea electronics modules to supplement the top-side electric power should the top-side electric power not be sufficient for a particular operation, e.g. closing or opening of a valve.

The first and second sub-sets may be overlapping. In other words, some (or all) of the plurality of battery pack modules may be configured to provide back-up electric power as well as supplement electric power. Alternatively, the first and second sub-sets may be distinct or non-overlapping, in which case each battery pack module is configured to provide either back-up electric power or supplement electric power.

Said plurality of subsea electronics modules may comprise a first subsea electronics module and a second subsea electronics module forming a redundant pair; and said plurality of battery pack modules may comprise:
a first battery pack module which is connectable to the first subsea electronics module to provide back-up electric power to the first subsea electronics module should power from the top-side power supply be interrupted; and
a second battery pack module which is connectable to the second subsea electronics module to provide back-up electric power to the second subsea electronics module should power from the top-side power supply be interrupted.

Should power from the top-side power supply be interrupted, the first battery pack module can be connected to the first subsea electronics module, and the second battery pack module can be connected to the second subsea electronics module, thus maintaining a powered redundant pair of subsea electronics modules.

Said control and battery module may also comprise at least one additional battery pack module which is connectable to at least one of the first and the second subsea electronics modules to act as a redundant power back-up pair for the first and/or second battery pack module should the first and/or second battery pack module fail in providing power to the first or second subsea electronics module, respectively. Allowing the at least one additional battery pack module to be shared between the first and the second subsea electronics modules and, consequently, serve both subsea electronics modules provides for a reliable yet cost-effective back-up power system.

The at least one additional battery pack module may comprise a third battery pack module which is connectable to the first subsea electronics module to form a redundant pair of power back-up battery pack modules for the first subsea electronics module together with the first battery pack module. The at least one additional battery pack module may also comprise a fourth battery pack module which is connectable to the second subsea electronics module to form a redundant pair of power back-up battery pack modules for the second subsea electronics module together with the second battery pack module.

The third battery pack module may be connectable exclusively to the first subsea electronics module to form a redundant pair of power back-up battery pack modules exclusively for the first subsea electronics module together with the first battery pack module. The fourth battery pack module may be connectable exclusively to the second subsea electronics module to form a redundant pair of power back-up battery pack modules exclusively for the second subsea electronics module together with the second battery pack module.

However, the second and fourth battery pack modules may advantageously be connectable also to the first subsea electronics module. This will allow the second and fourth battery pack modules, although primarily designated to provide back-up power to the second subsea electronics module, to act as additional back-up power sources for the first subsea electronics module in addition to the first and third battery pack modules.

Likewise, the first and third battery pack modules may advantageously be connectable also to the second subsea electronics module, thus allowing the first and third battery pack modules to act as additional back-up power sources for the second subsea electronics module in addition to the second and fourth battery pack module.

At least the third and fourth battery pack modules may be configured to provide also supplement electric power to the subsea electronics modules.

Each of said plurality of battery pack modules may comprise a battery package comprising battery cells and, for each subsea electronics module to which the battery pack module is connectable, an on/off switch configured to connect the battery cells to the respective subsea electronics module. Each of said plurality of battery pack modules may additionally or alternatively comprise fuses, e.g. electric fuses, arranged between the battery cells and the respective subsea electronics module, e.g. to avoid common mode failures for redundant batteries. Each of said plurality of battery pack modules may also comprise a charger sub-system, battery controller electronic, and remotely resettable electronic circuit breakers.

Each of said plurality of subsea electronics modules may comprise electric motor drives configured for powering and controlling said electric motors to operate the valves.

The plurality of subsea electronics modules and the plurality of battery pack modules may be arranged in a common retrievable container in the Christmas tree, thus allowing the control and battery modules to be replaced in a single operation, e.g. using an ROV.

Preferably, however, each subsea electronics module is arranged in a separate, retrievable container and be individually retrievable. In particular, each battery pack module may be arranged in a separate one atmospheric chamber which may contain the charger sub-system, the battery controller electronic, the on/off switches, the remotely resettable electronic circuit breakers, and the fuses in addition to the battery cells.

The subsea electronics modules are preferably arranged in a common, individually retrievable container.

Sub-sections of said retrievable containers, in particular sub-sections containing electrical wiring, may be filled with dielectric fluid and pressure compensated. Other sub-sections of the containers may be open to ambient seawater.

Each of the plurality of battery pack modules may be contained in a separate battery pack module sub-container, e.g. holding atmospheric, i.e. sea-level pressure, i.e. approximately 1013 hPa. Each of said plurality of subsea electronics modules may be contained in a separate subsea electronics module sub-container, e.g. holding atmospheric, i.e. sea-level pressure. This will provide additional protection for the battery pack modules and/or the subsea electronics modules should the retrievable container be damaged. The sub-containers may be filled with dry nitrogen.

Each of the plurality of battery pack modules may comprise a battery package comprising battery cells and, for each subsea electronics module to which the battery pack module is connectable, an on/off switch configured to control an electrical connection between the battery cells and the respective subsea electronics module.

According to a second aspect, the present disclosure provides a method of providing supplement electric power to a subsea hydrocarbon Christmas tree according to the above-discussed first aspect when electric power required for a desired valve operation exceeds electric power provided from the top-side power supply to the plurality of subsea electronics modules. The method comprises the step of connecting the at least one battery pack module to the plurality of subsea electronics modules to provide supplement electric power to the plurality of subsea electronics modules.

The method may comprise the step of:
when electric power required for the desired valve operation no longer exceeds electric power provided from the top-side power supply to the plurality of subsea electronics modules, disconnecting the at least one battery pack module from the plurality of subsea electronics modules and connecting the at least one battery pack module to the top-side power supply to charge the at least one battery pack module.

Said valve operation may comprise closing of valves of the Christmas tree, e.g. during emergency shut-down of the Subsea Christmas tree. In particular, said valve operation may comprise closing of any one of: a surface-controlled subsurface safety valve, a production master valve, a production wing valve, an annulus master valve, an annulus wing valve, a cross-over valve, a chemical injection valve and a choke valve of the Christmas tree.

With the abovementioned challenge in mind, and according to a third aspect, the present disclosure provides a subsea hydrocarbon Christmas tree comprising a control and battery module for controlling electrically actuated valves, each valve being actuated by an electric motor, the control and battery module comprising at least one subsea electronics module configured for receiving electric power provided from a top-side power supply to operate the valves; and at least one battery pack module.

The at least one battery pack module is connectable to the at least one subsea electronics module to provide supplement electric power to the at least one subsea electronics module should electric power required for a desired valve operation exceed electric power provided from the top-side power supply to the at least one subsea electronics module.

Consequently, the least one battery pack module is configured to be activated in power peak situations, thus allowing the top-side power distribution infrastructure to be dimensioned for a power rating which is less than the maximum power that may, in some rare situations, be required to operate the valves. This will reduce cost associated with top-side power lines or umbilicals.

In addition to providing supplement power for the operation of the valves, the least one battery pack module may advantageously be configured to form part of a power redundancy system of the control and battery module.

In particular, said at least one subsea electronics module may comprise a first subsea electronics module and a second subsea electronics module forming a redundant pair; and said at least one battery pack module may comprise:
a first battery pack module which is connectable to the first subsea electronics module to provide back-up electric power to the first subsea electronics module should power from the top-side power supply be interrupted; and
a second battery pack module which is connectable to the second subsea electronics module to provide back-up electric power to the second subsea electronics module should power from the top-side power supply be interrupted.

Should power from the top-side power supply be interrupted, the first battery pack module can be connected to the first subsea electronics module, and the second battery pack module can be connected to the second subsea electronics module, thus maintaining a powered redundant pair of subsea electronics modules.

Consequently, said at least one battery pack module may advantageously be configured to provide not only supplement power to the control and battery module, i.e. power supplanting uninterrupted top-side power, but also back-up power, i.e. power substituting interrupted top-side power, thus allowing the control and battery module to effectuate a redundantly powered shut-down or closing of the Christmas tree should power from the top-side power supply be interrupted.

Said at least one battery pack module may also comprise at least one additional battery pack module which is connectable to at least one of the first and the second subsea electronics modules to act as a redundant pair for the first and/or second battery pack module should the first or second battery pack module fail in providing power to the first or second subsea electronics module, respectively.

The at least one additional battery pack module, by virtue of being connectable to at least one of the first and the second subsea electronics modules, may form a back-up battery pack module for the first and/or the second subsea electronics module and, in particular, may form a redundant pair of power back-up battery pack modules together with the first and/or the second battery pack module.

The at least one additional battery pack module may be connectable to both the first and the second subsea electronics modules, thus allowing the at least one additional battery pack module to form a redundant pair of power back-up battery pack modules together with either one of the first and the second battery pack modules. Allowing the at least one additional battery pack module to be shared between the first and the second subsea electronics modules and, consequently, serve both subsea electronics modules provides for a reliable yet cost-effective back-up power system.

The at least one additional battery pack module may comprise a third battery pack module which is connectable to the first subsea electronics module to form a redundant pair of power back-up battery pack modules for the first subsea electronics module together with the first battery pack module. The at least one additional battery pack module may also comprise a fourth battery pack module which is connectable to the second subsea electronics module to form a redundant pair of power back-up battery pack modules for the second subsea electronics module together with the second battery pack module.

The third battery pack module may be connectable exclusively to the first subsea electronics module to form a redundant pair of power back-up battery pack modules exclusively for the first subsea electronics module together with the first battery pack module. The fourth battery pack module may be connectable exclusively to the second subsea electronics module to form a redundant pair of power back-up battery pack modules exclusively for the second subsea electronics module together with the second battery pack module.

However, the second and fourth battery pack modules may advantageously be connectable also to the first subsea electronics module. This will allow the second and fourth battery pack modules, although primarily designated to provide back-up power to the second subsea electronics module, to act as additional back-up power sources for the first subsea electronics module in addition to the first and third battery pack modules.

Likewise, the first and third battery pack modules may advantageously be connectable also to the second subsea electronics module, thus allowing the first and third battery pack modules to act as additional back-up power sources for the second subsea electronics module in addition to the second and fourth battery pack module.

Each of said plurality of battery pack modules may comprise a battery package comprising battery cells and, for each subsea electronics module to which the battery pack module is connectable, an on/off switch configured to connect the battery cells to the respective subsea electronics module. Each of said plurality of battery pack modules additionally or alternatively comprise an electric fuse arranged between the battery cells and the respective subsea electronics module.

Each of said first and second subsea electronics modules may comprise electric motor drives configured for powering and controlling said electric motors to operate the valves.

The first and second subsea electronics modules and the plurality of battery pack modules may be arranged in a common retrievable container in the Christmas tree, thus allowing the control and battery module to be replaced in a single operation, e.g. using an ROV. Alternatively, the modules may be arranged in separate, retrievable containers and be individually retrievable

Sub-sections of said retrievable containers, in particular sub-sections containing electrical wiring, may be filled with dielectric fluid and pressure compensated. Other sub-sections of the containers may be open to ambient seawater.

Each of the plurality of battery pack modules may be contained in a separate battery pack module sub-container, e.g. holding sea-level pressure, i.e. approximately 1013 hPa. Likewise, each of said first and second subsea electronics modules may be contained in a separate subsea electronics module sub-container holding sea-level pressure. This will provide additional protection for the battery pack and subsea electronics modules should the retrievable container be damaged. The sub-containers may be filled with dry nitrogen.

According to a fourth aspect, the present disclosure provides a method of providing supplement electric power to a subsea hydrocarbon Christmas tree according to the first aspect when electric power required for a desired valve operation exceeds electric power provided from the top-side power supply to the at least one subsea electronics module. The method comprises the step of connecting the at least one battery pack module to the at least one subsea electronics module to provide supplement electric power to the at least one subsea electronics module.

Said valve operation may comprise closing of valves of the Christmas tree, e.g. during emergency shut-down of the Subsea Christmas tree.

The method may comprise the steps of disconnecting the at least one battery pack module from the at least one subsea electronics module when the electric power required for the desired valve operation no longer exceeds the electric power provided from the top-side power supply to the at least one subsea electronics module; and connecting the at least one battery pack module to the top-side power supply to charge the at least one battery pack module.

In cases where the control and battery module comprises a plurality of battery pack modules, the method may comprise the step of connecting the plurality of battery pack modules to the at least one subsea electronics module to provide said supplement electric power to the at least one subsea electronics module. In other words, a plurality of battery pack modules may be activated to provide said supplement power.

Above-discussed preferred and/or optional features of each aspect of the invention may be used, alone or in appropriate combination, in the other aspects of the invention.

The invention for which patent protection is sought is specified in the accompanying claims.

### DESCRIPTION OF THE DRAWINGS

FIG. 1 discloses a hydrocarbon production Christmas tree comprising an embodiment of a control and battery module;

FIG. 2A is a diagram schematically illustrating the functioning and layout of an embodiment of a control and battery module;

FIG. 2B is a diagram schematically illustrating the functioning and layout of a further embodiment of a control and battery module;

FIG. 3 is a detailed diagram schematically illustrating the functioning and layout of a battery pack module of the control and battery module according to FIGS. 2A and FIG. 2B;

FIG. 4A is a diagram schematically illustrating the functioning and layout of a further embodiment of a control and battery module;

FIG. 4B is a diagram schematically illustrating the functioning and layout of a further embodiment of a control and battery module; and

FIG. 5 is a diagram schematically illustrating the functioning and layout of yet a further embodiment of a control and battery module.

In the drawings, like reference numerals have been used to indicate common parts, elements or features unless otherwise explicitly stated or implicitly understood by the context.

### DETAILED DESCRIPTION OF THE INVENTION

In the following, specific embodiments of a control and battery module will be described in more detail with reference to the drawings. However, it is specifically intended that the invention as specified in the following claims is not limited to the embodiments and illustrations contained herein but includes modified forms of the embodiments including portions of the embodiments and combinations of elements of different embodiments as come within the scope of the claims. It should be appreciated that in the development of any such actual implementation, as in any engineering or design project, numerous implementation-specific decisions must be made to achieve the developer's specific goals, such as compliance with system and/or business related constraints, which may vary from one implementation of the invention to another. Moreover, it should be appreciated that such a development effort might be complex and time consuming, but would nevertheless be a routine undertaking of design, fabrication and manufacture for the skilled person having the benefit of this disclosure.

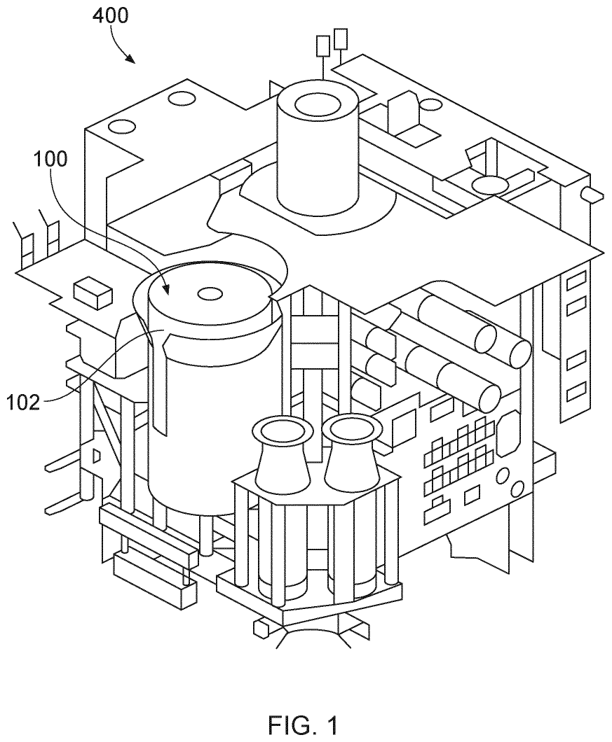

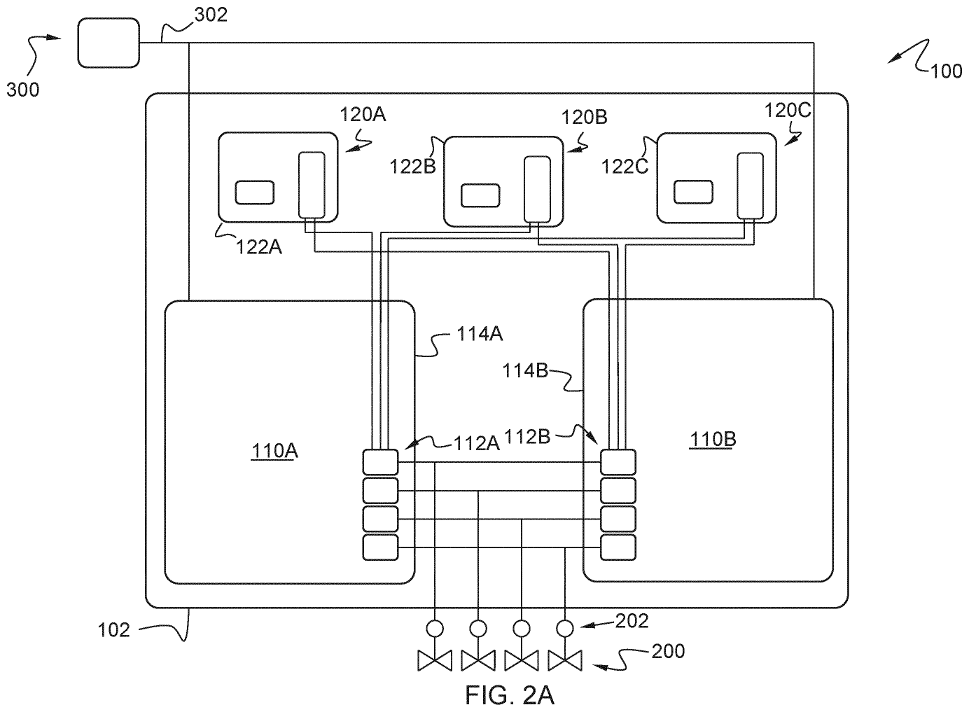

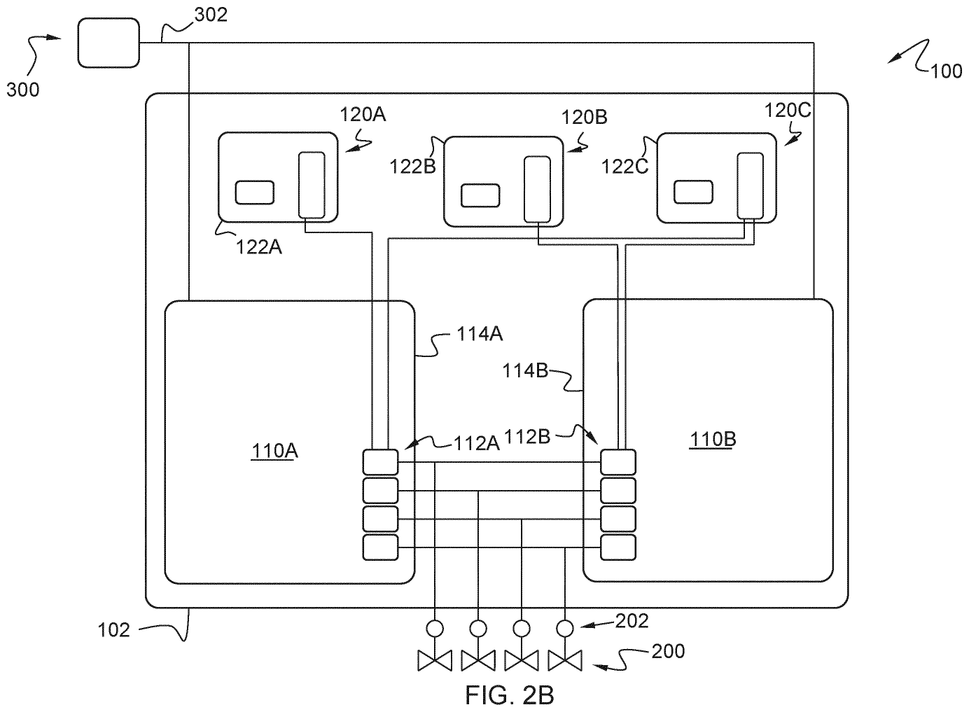

FIG. 1 discloses a subsea hydrocarbon Christmas tree 400 comprising a control and battery module 100 for controlling electrically actuated valves 200 (see FIG. 2A) associated with the Christmas tree 400. These valves may typically include a surface-controlled subsurface safety valve, production master and wing valves, annulus master and wing valves, a cross-over valve, chemical injection valves and choke valves.

Each valve 200 is actuated by an electric motor 202.

Referring now to FIG. 2A, the control and battery module 100 comprises a first 110A and a second 110B subsea electronics module or SEM. In other embodiments the control and battery module 100 may comprise only one SEM. In the present embodiment, however, the control and battery module 100 comprises two subsea electronics modules 110A, 110B, forming a redundant pair. In other embodiments the control and battery module 100 may comprise more than two SEMs.

Each subsea electronics module 110A, 110B is configured for receiving electric power provided from a top-side power supply 300 to operate the valves 200. Top-side power is provided to the subsea electronics modules 110A, 110B via an umbilical 302, as is schematically illustrated in FIG. 2A.

The control and battery module 100 further comprises a plurality of battery pack modules 120A, 120B, 120C. At least one of the battery pack modules 120A, 120B, 120C is connectable to the subsea electronics modules 110A, 110B to provide supplement electric power to the subsea electronics modules should electric power required for a desired valve operation exceed the electric power provided to the subsea electronics modules 110A, 110B from the top-side power supply 300 via the umbilical 302.

In other words, at least one of the battery pack modules is configured to be activated in power peak situations, i.e. when top-side power provided via the umbilical 302 is not sufficient to execute a desired valve operation, thus allowing the umbilical 302 to be dimensioned for a power rating which is less than the maximum power that may, in some rare situations, be required to operate the valves. Advantageously, however, all of the battery pack modules are configured to be activated in power peak situations to provide supplement power.

A power peak situation may for example occur during an emergency shutdown situation, during which a plurality of valves should advantageously be closed in parallel, i.e. simultaneously. In a system in which the umbilical 302 is dimensioned for providing power allowing only some of the valves to be shut in parallel, activating the battery pack modules 120A, 120B, 120C may allow more valves, and preferably all of the valves, to be closed in parallel, thus decreasing the emergency shutdown response time. Also, even if the umbilical 302 is dimensioned for allowing all of the valves to be closed in parallel, activating the battery pack modules 120A, 120B, 120C in such a situation may provide extra fault tolerance and redundancy to the system.

When electric power required for the desired valve operation no longer exceeds the electric power provided from the top-side power supply 300, the battery pack module or modules, as the case may be, are disconnected from the subsea electronics module 110A, 110B and the battery pack module or modules 120A, 120B, 120C are connected to the top-side power supply 300 to be recharged.

As previously stated, at least one of the battery pack modules 120A, 120B, 120C is connectable to the subsea electronics modules 110A, 110B to provide supplement electric power to the subsea electronics modules 110A, 110B should electric power required for a desired valve operation exceed the electric power provided to the subsea electronics modules 110A, 110B from the top-side power supply 300 via the umbilical 302. FIG. 2A illustrates an embodiment where each of the battery pack modules 120A, 120B and 120C are connectable to each of the subsea electronics modules 110A, 110B to provide supplement electric power. However, in other embodiments not all of the battery pack modules need to be connectable to all of the subsea electronics modules. For example, battery pack module 120A may be connectable only to subsea electronics modules 110A, battery pack module 120B may be connectable only to subsea electronics modules 110B, and battery pack module 120C may be connectable to subsea electronics module 110A and to subsea electronics module 110B. Such an embodiment is illustrated in FIG. 2B.

In the present embodiment, the plurality of the battery pack modules also forms part of a power redundancy system, thus allowing the battery pack modules to double as a supplement power system and a back-up power system. In particular, in the present embodiment the plurality of power back-up battery pack modules 120A, 120B, 120C comprises:
a first battery pack module 120A which is connectable to the first subsea electronics module 110A to provide back-up electric power to the first subsea electronics module 110A should power from the top-side power supply 300 be interrupted; and
a second battery pack module 120B which is connectable to the second subsea electronics module 110B to provide back-up electric power to the second subsea electronics module 110B should power from the top-side power supply 300 be interrupted.

Should power from the top-side power supply be interrupted, the first battery pack module 120A can be connected to the first subsea electronics module 110A, and the second battery pack 120B module can be connected to the second subsea electronics module 110B, thus maintaining a powered redundant pair of subsea electronics modules.

Consequently, the battery pack modules may advantageously be configured to provide not only supplement power to the control and battery module, i.e. power supplanting uninterrupted top-side power, but also back-up power, i.e. power substituting interrupted top-side power.

Said at least one battery pack module may also comprise an additional, third battery pack module 120C which is connectable to the first and the second subsea electronics modules 110A, 110B to act as a redundant pair for the first and second battery pack modules 120A, 120B should the first or second battery pack module fail in providing power to the first or second subsea electronics module, respectively.

The third battery pack module 120C, by virtue of being connectable to the first and the second subsea electronics modules, may form a back-up battery pack module for the first and the second subsea electronics module, respectively, and, in particular, may form a redundant pair together with the first and the second battery pack module, respectively.

Allowing the third battery pack module 120C to serve both the first and the second subsea electronics modules provides for a reliable yet cost-effective back-up power system.

Advantageously, the first battery pack module 120A may also be connectable to the second subsea electronics module 110B and the second battery pack modules 120B may also be connectable to the first subsea electronics module 110A, thus enabling each of the first, second and third battery pack modules 120A, 120B, 120C to be connected to each of the first and second subsea electronics modules 110A, 110B.

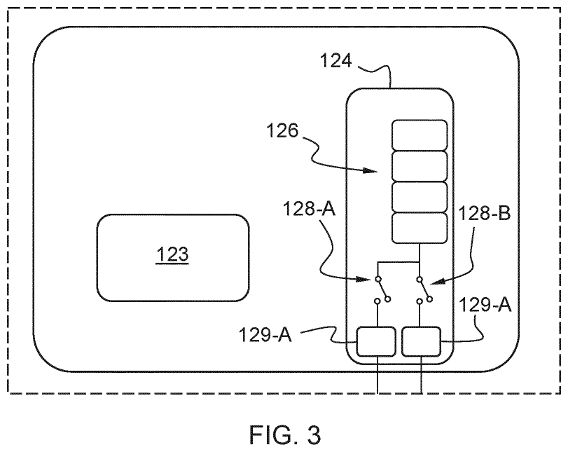

Each of the battery pack modules 120A, 120B, 120C comprises a battery control unit 123, a battery package 124 comprising battery cells 126 and, for each subsea electronics module 110A, 110B to which the battery pack module 120A, 120B, 120C is connectable, an on/off switch 128-A, 128-B configured to control (open and close) the electrical connection between the battery cells 126 and the respective subsea electronics module 110A, 110B (see FIG. 3). Each battery pack module 120A, 120B, 120C also comprises an electric fuse 129-A, 129-B arranged between the battery cells 126 and the respective subsea electronics module 110A, 110B to prevent electrical surge currents emerging from the battery cells 126 from damaging the subsea electronics module 110A, 110B.

In the present embodiment, the control and battery module 100 comprises a retrievable container 102 housing all of the components of the module 100, including the first and second subsea electronics modules 110A, 110B and the plurality of battery pack modules 120A, 120B, 120C. This will allow the control and battery module 100 to be replaced in a single operation, e.g. using an ROV.

Also, each of the battery pack modules 120A, 120B, 120C is contained in a separate battery pack module sub-container 122A, 122B, 122C. Likewise, each of the first and second subsea electronics modules 110A, 110B is contained in a separate subsea electronics module sub-container 214A, 214B. This will provide additional protection for the battery pack and subsea electronics modules should the retrievable container 102 be damaged. The pressure inside the sub-containers 122A, 122B, 122C and 214A, 214B may be sea-level pressure, thus allowing for use of standard components and battery cells in the battery pack modules.

In an embodiment each of the battery pack modules 120A, 120B, 120C may be individually retrievable. This will allow each of the battery pack modules 120A, 120B, 120C to be replaced individually, e.g. using an ROV. For example, each of the battery pack module sub-containers 122A, 122B, 122C may be individually retrievable, e.g. using an ROV. This will allow the battery pack modules 120A, 120B, 120C to be replaced leaving the subsea electronics modules 110A, 110B in place. This may be advantageous since the technical life span of a battery pack module may be shorter than the life span of the subsea electronics modules, thus necessitating replacement of the battery pack modules prior to replacement of the subsea electronics modules.

Each of the first and second subsea electronics modules 110A, 110B comprises electric motor drives 112A, 112B which are configured for powering and controlling the electric motors 202 operating the valves 200.

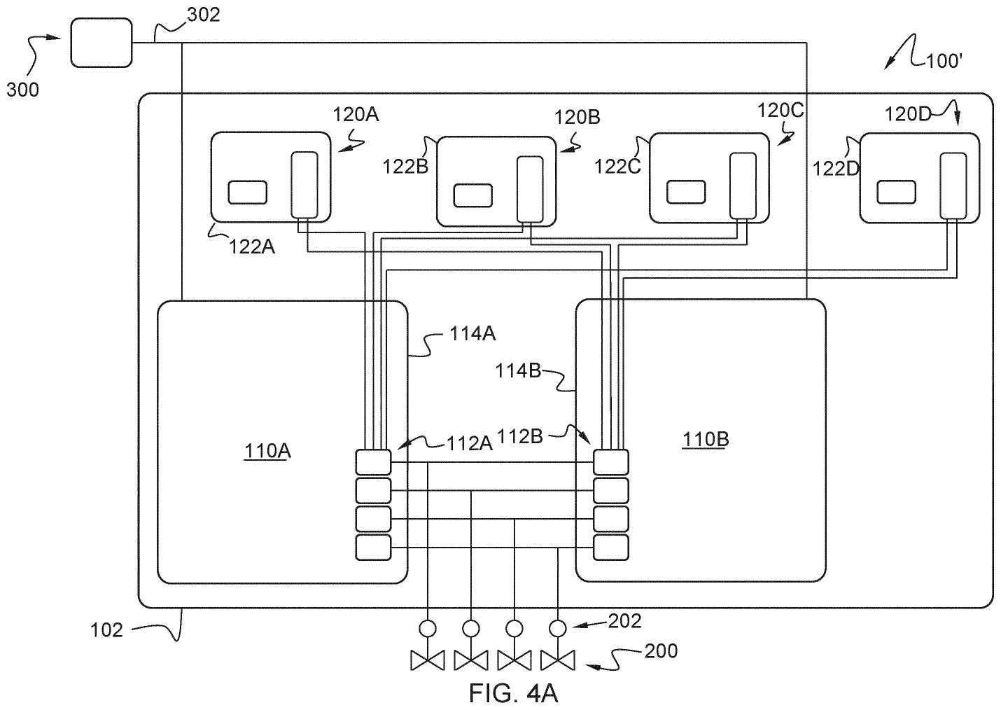

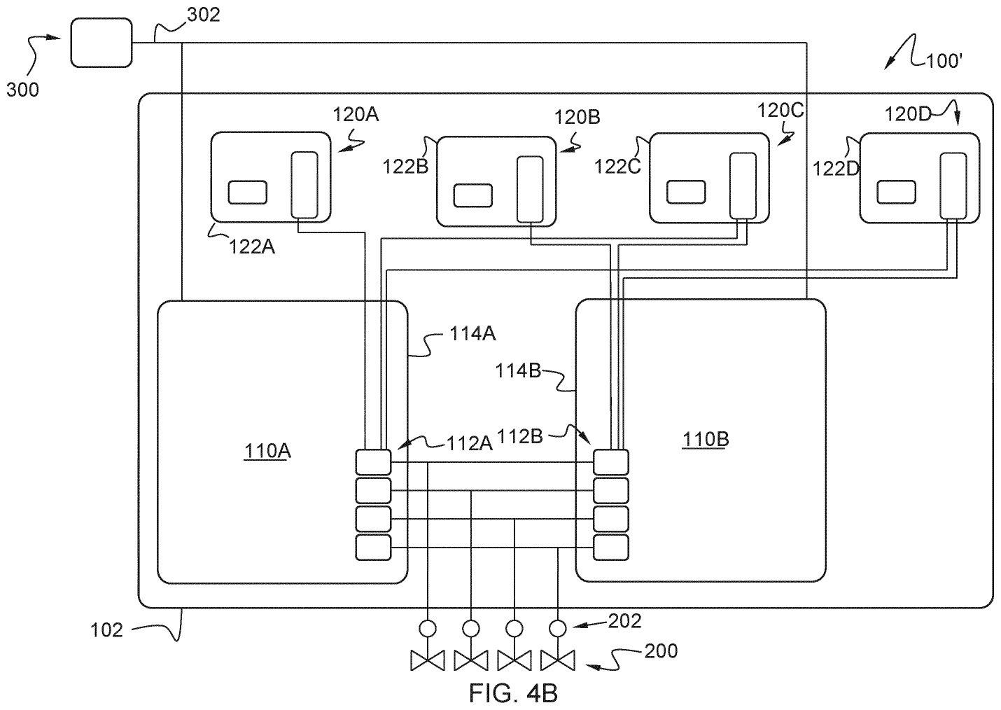

FIG. 4A illustrates an embodiment of a control and battery module 100′ in which the plurality of battery pack modules comprises an additional, fourth battery pack module 120D which is also connectable to the first and the second subsea electronics modules 110A, 110B, thus allowing each of the first, second, third and fourth battery pack modules to be connected to each of the first and second subsea electronics modules 110A, 110B to provide supplement electric power and, optionally, also pack-up power to the subsea electronics modules 110A, 110B.

FIG. 4B illustrates an alternative embodiment of a control and battery module 100′ in which battery pack module 120A is connectable only to subsea electronics modules 110A, battery pack module 120B is connectable only to subsea electronics modules 110B, and battery pack modules 120C and 120D are each connectable to subsea electronics module 110A and to subsea electronics module 110B.

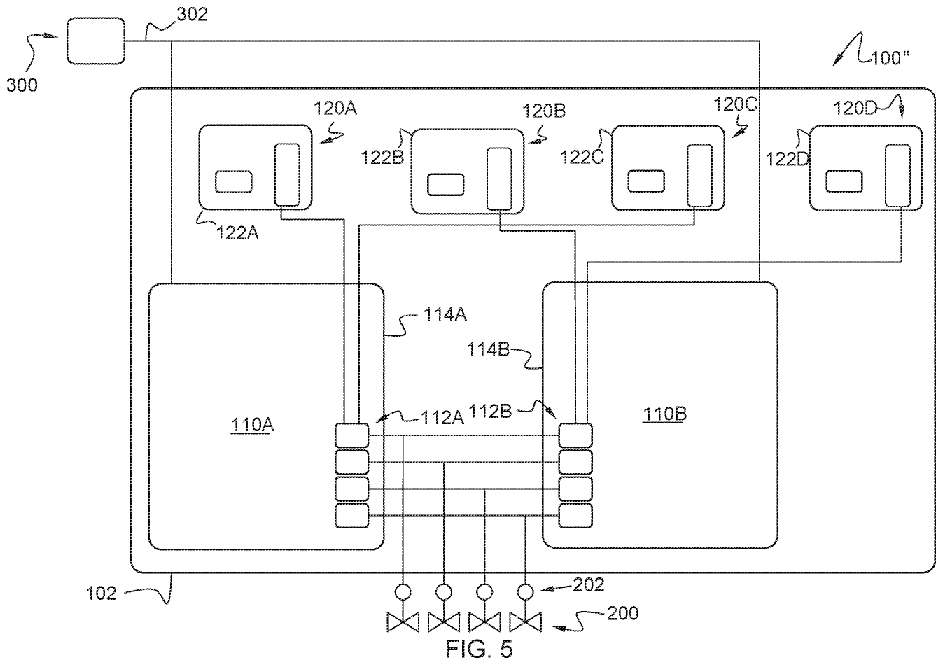

FIG. 5 illustrates an embodiment of a control and battery module 100″ in which the first 120A and third 120C battery pack modules are connectable exclusively to the first subsea electronics module 110A to provide supplement electric power exclusively to the first subsea electronics module 110A and, optionally, also form a redundant pair of power back-up battery pack modules exclusively for the first subsea electronics module 110A. The second 120B and fourth 120D battery pack modules are connectable exclusively to the second subsea electronics module 110B to provide supplement electric power exclusively to the second subsea electronics module 110B and, optionally, to form a redundant pair of power back-up battery pack modules exclusively for the second subsea electronics module 110B.

It is appreciated that certain features of the invention, which, for clarity, have been described above in the context of separate embodiments, may also be provided in combination in a single embodiment. Conversely, various features of the invention, which, for brevity, have been described in the context of a single embodiment, may also be provided separately or in any suitable sub-combination.

In the preceding description, various aspects of the apparatus according to the invention have been described with reference to the illustrative embodiment. For purposes of explanation, specific numbers, systems, and configurations were set forth in order to provide a thorough understanding of the apparatus and its workings. However, this description is not intended to be construed in a limiting sense. Various modifications and variations of the illustrative embodiment, as well as other embodiments of the apparatus, which are apparent to person skilled in the art to which the disclosed subject-matter pertains, may lie within the scope of the present invention as defined by the following claims.

1. A subsea hydrocarbon Christmas tree comprising a control and battery module for controlling a number of electrically actuated valves, each valve being actuated by an electric motor, the control and battery module comprising:
a plurality of subsea electronics modules configured for receiving electric power from a top-side power supply to operate the valves; and
a plurality of battery pack modules;
wherein the plurality of battery pack modules comprises at least one battery pack module which is connectable to the plurality of subsea electronics modules to provide supplement electric power to the plurality of subsea electronics modules should electric power required for a desired valve operation exceed electric power provided to the plurality of subsea electronics modules from the top-side power supply.

2. The Christmas tree according to claim 1, wherein said plurality of subsea electronics modules comprises a first subsea electronics module and a second subsea electronics module forming a redundant pair, and wherein said plurality of battery pack modules comprises:
a first battery pack module which is connectable to the first subsea electronics module to provide back-up electric power to the first subsea electronics module should power from the top-side power supply be interrupted; and
a second battery pack module which is connectable to the second subsea electronics module to provide back-up electric power to the second subsea electronics module should power from the top-side power supply be interrupted.

3. The Christmas tree according to claim 2, further comprising at least one additional battery pack module which is connectable to at least one of the first and the second subsea electronics modules to act as a redundant power back-up pair for the first and/or second battery pack module should the first and/or second battery pack module fail in providing power to the first and/or second subsea electronics module.

4. The Christmas tree according to claim 1, wherein each of said plurality of subsea electronics modules comprises electric motor drives configured for powering and controlling said electric motors to operate the valves.

5. The Christmas tree according to claim 1, wherein the plurality of subsea electronics modules and the plurality of battery pack modules are arranged in a common container in the Christmas tree.

6. The Christmas tree according to claim 1, wherein each of the plurality of battery pack modules comprises a battery package comprising battery cells and, for each subsea electronics module to which the battery pack module is connectable, an on/off switch configured to control an electrical connection between the battery cells and the respective subsea electronics module.

7. The Christmas tree according to claim 1, wherein each of said plurality of battery pack modules is contained in a respective battery pack module sub-container holding atmospheric pressure.

8. The Christmas tree according to claim 1, wherein each of said plurality of subsea electronics modules is contained in a respective subsea electronics module sub-container.

9. A method of providing supplement electric power to a subsea hydrocarbon Christmas tree according to claim 1 when electric power required for a desired valve operation exceeds electric power provided from the top-side power supply to the at least one subsea electronics module, the method comprising:
connecting the at least one battery pack module to the plurality of subsea electronics modules to provide supplement electric power to the plurality of subsea electronics modules.

10. The method according to claim 9, further comprising:
when electric power required for the desired valve operation no longer exceeds electric power provided from the top-side power supply to the plurality of subsea electronics modules, disconnecting the at least one battery pack module from the plurality of subsea electronics modules and connecting the at least one battery pack module to the top-side power supply to charge the at least one battery pack module.

11. The method according to claim 9, wherein the step of connecting the at least one battery pack module to the plurality of subsea electronics modules to provide supplement electric power to the plurality of subsea electronics modules comprises:
connecting the plurality of battery pack modules to the plurality of subsea electronics modules to provide said supplement electric power to the plurality of subsea electronics modules.

12. The method according to claim 9, wherein said valve operation comprises closing of valves of the Christmas tree.

13. The method according to claim 12, wherein said valve operation comprises closing of any one of: a surface-controlled subsurface safety valve, a production master valve, a production wing valve, an annulus master valve, an annulus wing valve, a cross-over valve, a chemical injection valve and a choke valve of the Christmas tree.
